(19) United States
(12) Patent Application Publication
(10) Pub. No.: US 2009/0124131 A1
(43) Pub. Date: May 14, 2009

(54) THERMOCOUPLE ADAPTER

(75) Inventors: Rex L. Breunsbach, Clackamas, OR (US); Philip M. Krebs, West Linn, OR (US); Paul M. Austen, Milwaukie, OR (US); Grant W. Peterson, Tualatin, OR (US)

Correspondence Address: KLARQUIST SPARKMAN, LLP, 121 SW SALMON STREET, SUITE 1600, PORTLAND, OR, 97204, US

(73) Assignee: Electronic Controls Design

(21) Appl. No.: 11/938,177

(22) Filed: Nov. 9, 2007

(51) Int. Cl. H01R 33/88; H01R 25/00

(52) U.S. Cl. 439/652; 439/638; 439/650; 439/913

(57) ABSTRACT

An adapter is disclosed that allows simplified connection of thermocouples to a data logger. In one embodiment, multiple thermocouple connectors are positioned within the adapter. The adapter then attaches to a data logger with a simple male/female connection scheme so that the multiple thermocouple connectors are simultaneously coupled to the data logger. The thermocouple connectors are already organized within the adapter so that each thermocouple is plugged into its proper location on the data logger.

### FIELD

The present disclosure relates to methods and adapters for mechanically and electrically connecting thermocouples to data loggers.

### BACKGROUND

Conveyor ovens (also called furnaces) are used in a variety of industries including the electronics, baking, and painting industries. Generally, conveyor ovens have multiple heating zones and may have one or more cooling zones through which product is conveyed. The heating zones are thermally isolated from each other by air curtains or other means. Such thermal isolation allows each zone to be maintained at a temperature that differs from other zones in the oven. A particular advantage of conveyor ovens with multiple heating zones is that products can be heated to different temperatures at different times and rates as they pass through the oven.

In the electronics industry, conveyor ovens, known as reflow ovens, are used to electrically bond electronic components to printed circuit boards (PCBs) with solder paste. Typically, the soldering process within a conveyor oven can be characterized by the following phases: preheat or ramp phase, the dwell or soak phase, the reflow or spike phase and the cooling phase. In the preheat phase, the solder paste is heated from room temperature to a preheat temperature to promote evaporation of the solvents, or carriers, in the solder paste. During the soak phase, the solder paste is permitted to “soak” for a predetermined period of time at a temperature range at which the flux, the active ingredient in the solder paste, becomes active. In the reflow phase, the solder paste is heated above the liquidous, or melting temperature of the solder for a predetermined period of time sufficient to permit reflow (i.e., melting or wetting) of the solder paste. In the cooling phase, the solder joint solidifies, thereby electrically bonding the components to the circuit board.

Typically, the thermal requirements for a solder paste (also called solder paste specifications) for preheat, soak and reflow phases are specified by the manufacturer of the paste. Generally speaking, “profiling” is the process of determining the process settings for the oven that will best satisfy the thermal requirements of the solder paste without damaging the electronic components. Such process settings may include, for example, the temperature settings of each oven zone and the oven conveyor speed.

Devices for measuring the temperature profile of a product conveyed through an oven (i.e., the temperature response of the product) are known. For example, electronic data loggers (also called data collectors or monitors) have been developed that attach thermocouple sensors to a test PCB. One such data logger, the M.O.L.E.® temperature profiler, is an oven profiler sold commercially by Electronic Controls Design, Inc., of Milwaukie, Oreg. Beyond the M.O.L.E.®, the test PCB has various thermocouples strategically placed thereon. Traditionally, each thermocouple is connected directly to the electronic data logger. The electronic data logger is physically spaced apart from the PCB so as not to affect the heating of the PCB and thereby cause inaccurate temperature profiling. The data logger stores temperature information measured by the thermocouples and that information can be processed to determine and control the optimal temperature profile of the product.

Once the data logger has passed through the oven, the collected data is downloaded to a computer using a special docking station, or via RF or cable. A software package located on the computer graphically illustrates a temperature profile of the collected data and provides a comparison to an optimal profile. The operator estimates changes to the oven settings for reducing the difference between the temperature response of the assembly and the desired thermal profile to within an allowable tolerance. The operator adjusts the oven settings and repeats the process until the appropriate thermal requirements for the solder paste are reached.

If several thermocouples are used, however, the thermocouples can quickly become tangled and difficult to organize. Additionally, it is difficult to coordinate into which data logger slots the thermocouples should be plugged. Even further, there is increasing commercial pressure to process smaller parts that require more temperature sensors to obtain a proper temperature profile. Ovens are also decreasing in size, forcing data loggers to become smaller. With the decrease in data logger size and the increase in inputs to the data loggers, the connection schemes for commercially available thermocouple connectors are not sustainable.

It is desirable to increase the number of thermocouples that can be attached to a data logger in an efficient and user-friendly manner. The present disclosure is aimed at resolving this and related problems in the art.

### SUMMARY

A first embodiment of the present disclosure describes an adapter for a data logger comprising a housing and at least two removable thermocouple connectors positioned within the housing. The housing allows easy organization of the thermocouples and allows multiple thermocouples to be simultaneously plugged into the data logger with a single male/female-type snap fit.

A second embodiment of the present disclosure describes a method of thermal profiling comprising grouping multiple thermocouples together. Each thermocouple comprises a thermocouple junction electrically connected to a first lead and a second lead. The first lead and the second lead of each thermocouple are connected to a thermocouple connector. The multiple thermocouple connectors are coupled inside of a single housing, the housing is connected to a data logger, and temperature data from the multiple thermocouples is collected via the thermocouple connectors.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates a circuit board and a data logger being transported along a conveyor belt inside an oven with multiple temperature zones according to the present disclosure.

FIG. 2 illustrates multiple thermocouples attached on one end to different areas of a circuit board and attached on the other end to a data logger according to the present disclosure.

FIG. 3 illustrates a data logger with multiple thermocouple adapters attached thereto.

FIG. 4 illustrates a top view of an adapter according to the present disclosure.

FIG. 5 illustrates a detailed view of the adapter with multiple thermocouples arranged therein.

FIG. 6 illustrates an exploded view of a thermocouple adapter according to the present disclosure.

FIG. 7 is a flowchart illustrating a method of using a data logger, thermocouples, and thermocouple adapters.

### DETAILED DESCRIPTION

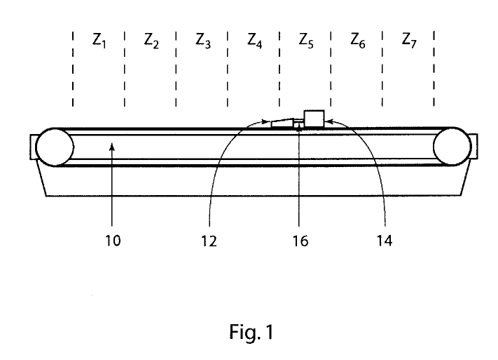

FIG. 1 shows a conveyor belt 10 of an oven with multiple temperature zones Z₁-Z₇. A circuit board 12 is shown on top of the conveyor belt 10. The circuit board 12 is attached to a data logger 14 by a series of wires 16, some of which may include thermocouples as will be explained in more detail below. The data logger 14 collects temperature data of various points on the circuit board 12 by using thermocouple junctions (not shown) attached to the circuit board. The temperature data is transmitted to the data logger via the series of wires 16. After the data logger 14 collects the temperature data, it passes the data to a computer 18 which is operable to analyze the data and display corresponding oven profile information to a user. It will be recognized that the present embodiments are not limited to conveyor ovens or the use of circuit boards. The embodiments described herein can be used to measure any temperature data collected from thermocouples independent of the operating environment.

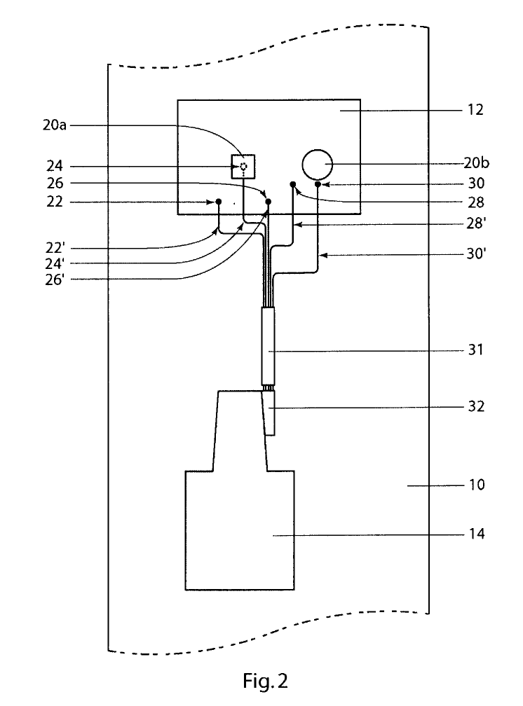

FIG. 2 shows the connection of the data logger 14 to the circuit board 12 in more detail. The circuit board 12 of this embodiment is positioned on a conveyor belt 10 and includes two elements 20a, 20b. The elements 20a, 20b could be one of a transistor, a resistor, a capacitor, a microchip, or any other element that would be known in the art. Two elements are shown only for simplicity, as a circuit board typically includes numerous elements. A first thermocouple junction 22 is attached near the first element 20a. A second thermocouple junction 24 is positioned between the circuit board 12 and the first element 20a. A third thermocouple junction 26 and a fourth thermocouple junction 28 are affixed to various other sections of the circuit board 12 and a fifth thermocouple junction 30 is affixed near the second element 20b. It will be recognized that although only five thermocouple junctions are described here, it is envisioned that other embodiments could have any number of more or fewer thermocouple junctions

Each of the thermocouple junctions 22, 24, 26, 28, 30 includes two thermocouple leads (not shown) that are wrapped inside of a protective sheath 22′, 24′, 26′, 28′, 30′ that connect the thermocouple junctions to a thermocouple adapter 32. FIG. 2 shows that at a point between the circuit board 12 and the adapter 32 each of the protective sheaths 22′, 24′, 26′, 28′, 30′ merge and are enclosed by an outer cover 31. It will be understood that the sheaths could merge at any point between the board 12 and the adapter 32. For example, they could be tied or taped together, molded together, or be collected inside the outer cover 31.

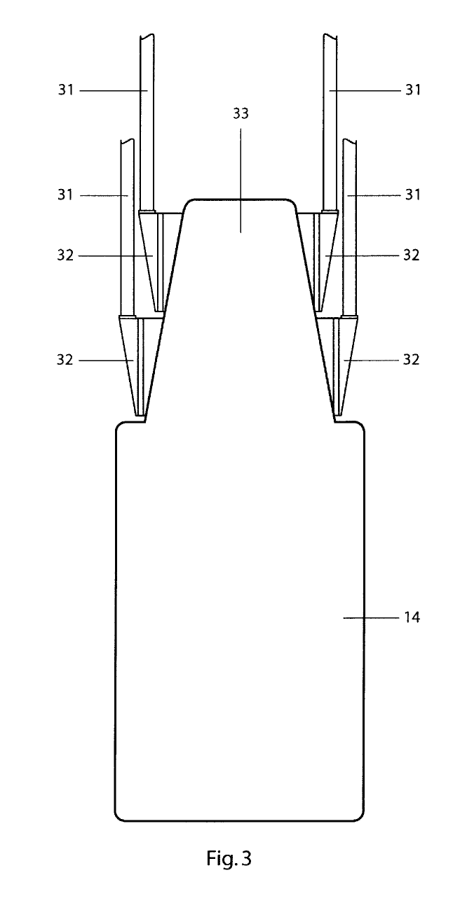

FIG. 3 shows four of the adapters 32 attached to a data logger 14. Each of the adapters 32 has at least one cover 31 protruding from it. It can be seen that the data logger 14 has a tapered width as it approaches one of the ends 33 of the data logger 14. This tapering allows adjacently coupled adapters to be offset from one another in the longitudinal direction of the data logger, thereby freeing thermocouple leads extending from the adapters to pass unobstructed and keeping the overall width of the data logger/adapter assembly relatively constant. By offsetting the adapters each of the outer covers 31 is configurable to be generally parallel with each other. This embodiment illustrates four adapters connected to the data logger, two on each side, but one of skill in the art will recognize that alternate embodiments could include any number of adapters on each side of the data logger. One skilled in the art will also understand that rather than an outer cover 31 protruding from the adapter 32, one or more of the protective sheaths 22′, 24′, 26′, 28′, 30′ could individually extend from the adapter without being collected within the outer cover.

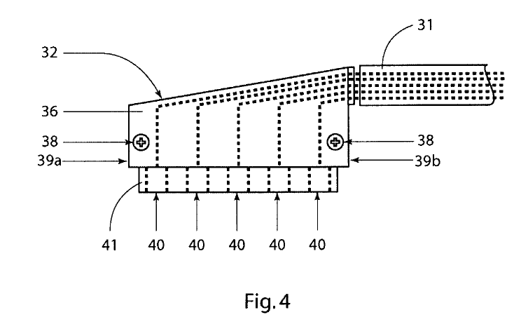

FIG. 4 shows the adapter 32 in more detail. The adapter 32 includes a housing 36 with two screws 38 situated on a first end 39a and a second end 39b of the housing for easy opening and closing of the housing. One skilled in the art will recognize that other fasteners or other numbers of fasteners may be substituted for the screws 38. The adapter 32 includes five thermocouple connectors 40 positioned generally inside of the housing 36 and generally aligned with an elongated connector 41 that extends along the length of the housing from the first end 39a to the second end 39b. Each of the thermocouple connectors 40 is electrically connected to thermocouple leads (not shown) as will be described in further detail below. The protective sheaths 22′, 24′, 26′, 28′, 30′ extend from each of the thermocouple connectors 40 respectively and exit the housing 36 from a single location where they are collected into the outer cover 31. Though five connectors 40 are shown, the housing 36 could include any number of connectors. In the present embodiment the number of connectors 40 could be anywhere between one and five, though in other embodiments the housing 36 could be elongated and the maximum number of connectors within the housing could be increased to meet specified design needs. Further, it will be recognized that although the elongated connector 41 is shown as being a “male” type connector, the connector could also be a “female” type connector and designed to plug into a male port on a data logger.

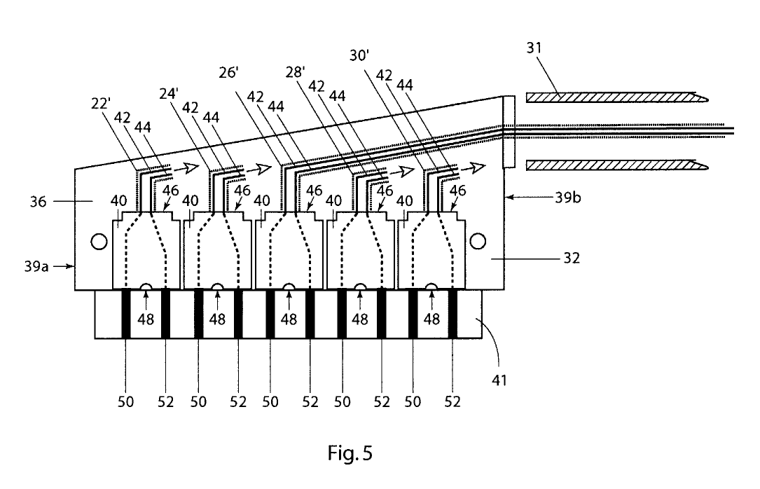

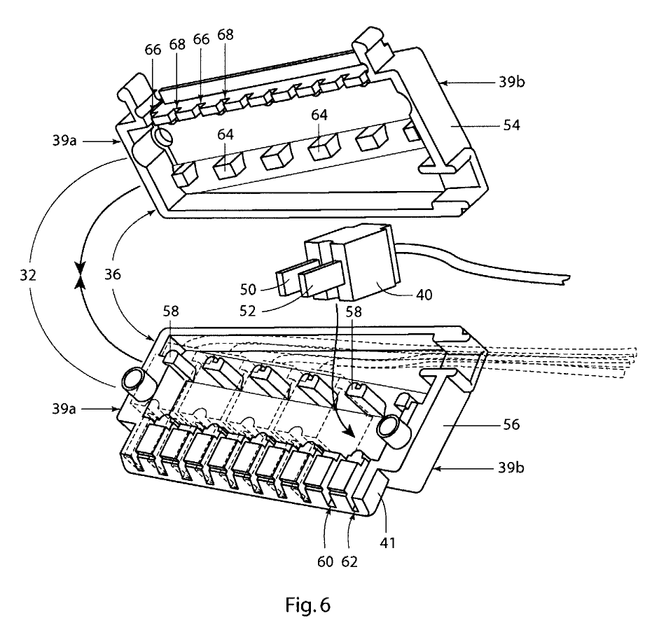

FIG. 5 depicts a cutaway version of the adapter 32 showing the internal wiring configuration of the thermocouple connectors 40 aligned in the elongated connector 41 in greater detail. Five thermocouple connectors 40 are arranged inside of the housing 36 including a first end 39a and a second end 39b. Each connector 40 includes a first thermocouple lead 42 and a second thermocouple lead 44 that extend from a first side 46 of the connector and into one of the protective sheaths 22′, 24′, 26′, 28′, 30′. For ease of illustration, only one set of thermocouple leads and corresponding sheathing are shown extending from housing 36, but it is understood that the other thermocouple leads and sheathing are also so situated. The first thermocouple lead 42 extends from a second side 48 of the connector 40 to form a first connecting pin 50. The second thermocouple lead 44 extends to form a second connecting pin 52. The connecting pins are separated from each other and held in place by slots in the elongated connector 41 as will be explained with reference to FIG. 6. Thus in this embodiment, the first and second connecting pins 50, 52 are portions of the first and second thermocouples leads 42, 44 that protrude from the thermocouple connector 40. In alternative embodiments the first and second connecting pins 50, 52 are physically separate from the first and second thermocouples leads 42, 44 and are electrically connected to them through mechanical compression, welding, or any other manner known in the art.

FIG. 6 depicts an exploded view of the adapter 32 including a single thermocouple connector 40 and illustrates where it would fit in relation to the housing 36 with an elongated connector portion 41. Four other thermocouple connectors are shown in dashed lines for the sake of presenting a clear view of the configuration of the housing 36. The housing 36 comprises a top portion 54 and a bottom portion 56, each having a first end and a second end 39a, 39b. The bottom portion 56 includes a number of posts 58 defining discrete spaces for a thermocouple connector 40 to occupy when placed inside of the bottom portion. The bottom portion 56 further includes a first slot 60 and a second slot 62 in the elongated connector portion 41 for each thermocouple connector 40. The first slot 60 and the second slot 62 are configured to support the first and second connecting pins 50, 52 of each respective thermocouple connector 40. The top portion 54 similarly includes a plurality of posts 64 defining discrete spaces for the thermocouple connectors, as well as first and second slots 66, 68 that align with slots 60, 62 to form a receptacle holding connecting pins 50, 52 in position within the elongated connector.

In this embodiment the one or more thermocouple connectors 40 are placed into the bottom portion 56 as defined by the posts 58 with the first and second connecting pins 50, 52 positioned within the first and second slots 60, 62. The top portion 54 is then placed over the bottom portion 56 and the two portions are secured by one or more screws or fasteners as described above. In this manner it is envisioned that the top portion 54 and the bottom portion 56 hold each of the thermocouple connectors 40 securely and separately within the housing 36. It will be further recognized that the first and second slots 66, 68 of the top portion 54 and the first and second slots 60, 62 of the bottom portion 56 securely hold the first and second connecting pins 50, 52 of each of the respective thermocouple connectors 40 while simultaneously protecting and exposing the first and second connecting pins of that connector within the elongated connector 41. In this way, the connectors 40 are in electrical contact with a data logger when the adapter 32 is inserted into a port in the data logger as described above but otherwise not susceptible to mechanical damage from bending or striking that could come from activities such as being dropped or handled roughly.

It will be recognized that this configuration offers several advantages over the prior art. For example, with the thermocouples properly aligned within the adapter, an operator simply needs to snap the entire adapter into the data logger. The adapter is sensitive to orientation and can only plug in one way, making it error proof. Additionally, because multiple thermocouples are plugged in simultaneously, the speed at which the operator can plug and unplug thermocouples from the data logger is greatly increased, and with no concern of errors by plugging a thermocouple into the wrong location on the data logger. Additionally, the adapter can be configured to uniquely identify a given thermocouple quickly and easily to a user or a data logger so that it is readily known which thermocouple junction corresponds to a thermocouple connector at a first position inside of the adapter.

An additional advantage is that each of the thermocouple connectors is separate from each of the other thermocouple connectors inside of an adapter. A thermocouple including a sheath, a thermocouple junction, thermocouple leads, and a thermocouple connector can be replaced independently of each of the other thermocouples in a given adapter in the event of damage to one or more of the elements. Additionally, if fewer thermocouples are desired or one or more are damaged then each thermocouple is independently removable and replaceable from a given adapter.

Still further, the adapter allows for easy color coding by affixing labels on the adapter that are matched to color coded sheaths to associate a thermocouple with its respective position in the adapter.

Finally, by extending the first and second thermocouple leads through the thermocouple connector to serve as the first and second connecting pins, the number of connections and elements in a thermocouple is further minimized. Thus, there are fewer parts to malfunction which can lead to a reduced cost of maintenance and repair.

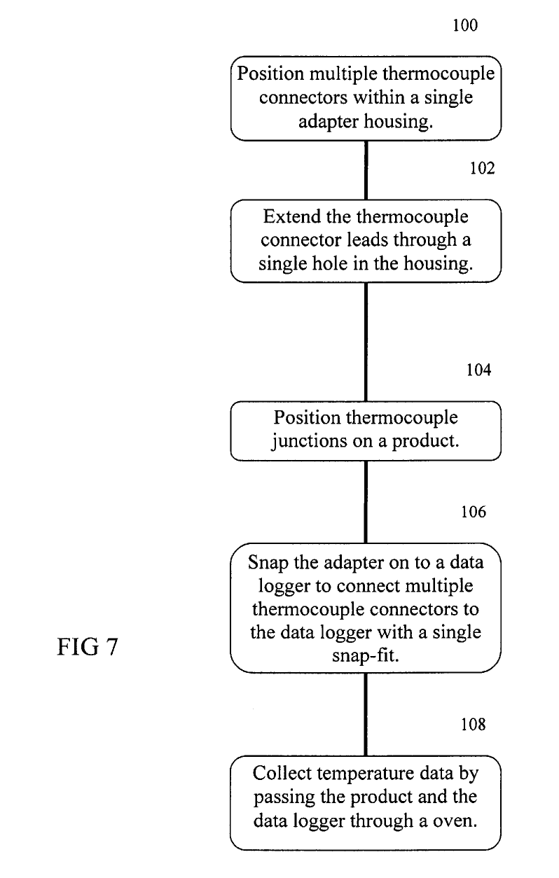

FIG. 7 is a flow chart illustrating one method in which the adapter of the present disclosure could be utilized. In the first step 100, multiple thermocouple connectors are positioned within a single adapter housing. The thermocouple leads are then extended through a single hole located at the end of the housing 102 and the housing is locked down with screws or other securing means. Each thermocouple has a respective thermocouple junction that is positioned on a product, such as a circuit board 104. A user then snaps the adapter onto a data logger so that the multiple thermocouple connectors are connected to the data logger substantially simultaneously with a single snap-fit 106. In particular, the male connector of the adapter fits into a female receptacle on the data logger and is keyed to ensure the orientation is correct. Finally, temperature data is collected by passing the product and the data logger through a oven 108 (e.g., conveyor oven). The adapter can then be snapped back off of the data logger Further, though the adapter is discussed as being connected to the data logger with a single snap-fit in step 106, the snap-fit is merely exemplary and other methods of connection may be used to hold the adapter to the data logger in a secure manner.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. An adapter for connecting thermocouples to a data logger, comprising:
an outer housing having first and second ends, and first and second sides;
multiple thermocouple connectors positioned within the housing; and
an elongated connector formed longitudinally along one of the sides of the outer housing, the elongated connector designed to plug the multiple thermocouple connectors into the data logger.

2. The adapter of claim 1, wherein the elongated connector connects to the data logger with a snap fit.

3. The adapter of claim 1, wherein each thermocouple connector includes at least first and second pins.

4. The adapter of claim 3, wherein the elongated connector is a male-type connector and wherein the first and second pins of each thermocouple connector extend into the elongated male-type connector to form pins of the adapter.

5. The adapter of claim 3, wherein the thermocouple connectors include first and second thermocouple leads coupled to the first and second pins, respectively, and the pins and leads are coupled together within a single injection-molded part.

6. The adapter of claim 1, wherein the multiple thermocouples includes at least three thermocouples.

7. The adapter of claim 1, wherein the multiple thermocouples includes at least four thermocouples.

8. The adapter of claim 1, wherein the multiple thermocouples includes at least five thermocouples

9. The adapter of claim 1, wherein the outer housing includes mating upper and lower portions forming a hole in one of the ends thereof, the hole being sized to receive all thermocouple leads coupled to the thermocouple connectors in the housing.

10. The adapter of claim 1, wherein the outer housing includes mating upper and lower portions, the upper portion having a first set of multiple spaced-apart notches and the lower portion having a second set of multiple spaced-apart notches, the first and second set of notches together forming slots within the elongated connector.

11. The adapter of claim 1, wherein the thermocouple connectors are removably mounted within the housing.

12. The adapter of claim 1, including the data logger and wherein the data logger has a tapered end for facilitating connection of the adapter.

13. A method for connecting thermocouples to a data logger, comprising:
coupling multiple thermocouple connectors inside of a single housing having first and second ends, and first and second sides;
connecting the housing to a data logger via an elongated connector formed longitudinally along one of the sides of the housing, the elongated connector designed to plug the multiple thermocouple connectors into the data logger with a single snap fit; and
collecting temperature data in the data logger from the multiple thermocouples via the thermocouple connectors.

14. The method of thermal profiling of claim 13, wherein coupling includes positioning at least five thermocouple connectors inside the housing.

15. The method of thermal profiling of claim 13, wherein each of the multiple thermocouple connectors is independently removable from the housing.

16. The method of thermal profiling of claim 13, wherein each of the thermocouple connectors includes a first and a second connecting pin in electrical communication with the data logger when the housing is connected to the data logger.

17. The method of thermal profiling of claim 16, wherein the first connecting pin of a thermocouple connector is the first lead of a thermocouple, and the second connecting pin of the thermocouple connector is the second lead of the thermocouple.

18. The method of thermal profiling of claim 13, wherein collecting further comprises affixing at least one thermocouple junction to a product and collecting temperature data using the thermocouple junction.

19. The method of thermal profiling of claim 18, wherein collecting further comprises collecting the temperature data as the product travels through an oven with multiple temperature zones.

20. The method of thermal profiling of claim 19, wherein the data logger, the thermocouples, and the circuit board travel between the multiple temperature zones of the oven via a conveyor belt.

21. An adapter for connecting thermocouples to a data logger, comprising:
means for positioning multiple thermocouple connectors in an ordered row;
means for connecting the multiple thermocouple connectors to a data logger with a single snap fit; and
means for storing temperature data in the data logger received from the multiple thermocouple connectors.
